(19) United States
(12) Patent Application Publication
(10) Pub. No.: US 2022/0283853 A1
(43) Pub. Date: Sep. 8, 2022

(54) ANALYSIS SYSTEM, ANALYSIS METHOD, AND ANALYSIS PROGRAM

(71) Applicant: NIPPON TELEGRAPH AND TELEPHONE CORPORATION, Tokyo (JP)

(72) Inventors: Yuhei KAWAKOYA, Tokyo (JP); Makoto IWAMURA, Tokyo (JP); Jun MIYOSHI, Tokyo (JP); Yuto OTSUKI, Tokyo (JP)

(73) Assignee: NIPPON TELEGRAPH AND TELEPHONE CORPORATION, Tokyo (JP)

(21) Appl. No.: 17/632,643

(22) PCT Filed: Aug. 7, 2019
(86) PCT No.: PCT/JP2019/031205

§ 371 Date: Feb. 3, 2022

(51) Int. Cl. G06F 9/48

(52) U.S. Cl. CPC G06F 9/4881

(57) ABSTRACT

An analysis system includes processing circuitry configured to extract each running process and each thread in each process from data that records a state of a memory of an analysis object apparatus, acquire an object belonging to the process or the thread having been extracted, and specify a same object belonging to a plurality of processes or a plurality of threads among objects acquired and associate the plurality of processes or the plurality of threads to which the same object belongs.

### TECHNICAL FIELD

The present invention relates to an analysis system, an analysis method, and an analysis program.

### BACKGROUND ART

Conventionally, with the proliferation of computers and the Internet, cyberattacks have also become more sophisticated and diversified. In a targeted attack aimed at a specific organization, unknown computer viruses (malware) are often used, making such a targeted attack difficult to prevent in advance. Therefore, once an attack is sustained, response such as specifying a source and minimizing damage needs to be carried out as swiftly as possible.

One of the methods used in an incident response that is carried out in response to such an attack is memory analysis of a victim terminal known as memory forensics. A computer runs while saving instructions (codes) being executed and data being used on a memory. Therefore, the memory contains an execution state of an instant such as a state of applications that were running at that instant, files that were opened, resources such as registries, codes that were executed and data that was read or written, communication destinations, and transmitted and received data. In other words, by analyzing data remaining on the memory, an assessment as to what was happening at that instant can be made.

### CITATION LIST

### Non Patent Literature

[NPL 1] Ispoglou, K. K., Payer, M.: “malWASH: Washing malware to evade dynamic analysis”, 10th USENIX Workshop on Offensive Technologies (WOOT 16), USENIX Association (2016)
[NPL 2] Otsuki, Y., Kawakoya, Y., Iwamura, M., Miyoshi, J., Ohkubo, K.: “Building stack traces from memory dump of windows x64”, Digital Investigation 24, S101-S110 (2018)

### SUMMARY OF THE INVENTION

### Technical Problem

However, there is a problem with conventional memory forensics techniques in that, when a plurality of programs including malware are running while cooperating with each other, a relationship between respective processes or threads is sometimes unrecognizable and sufficient analysis cannot be performed.

For example, conventional memory forensics techniques are mainly limited to collecting information on each process or thread being executed at the time of acquisition of a memory dump being stored on a memory by an OS. On the other hand, with respect to a parent-child relationship between processes and a process to which each thread belongs, there is a lack of techniques for elucidating the relationships between processes or the relationships between threads.

In addition, running a plurality of processes and/or threads in cooperation with each other through multiprocessing, multithreading, or the like is common practice regardless of malware or benign applications. Furthermore, some malware inject codes in a distributed manner into running benign applications, in which case the injected code fragments operate in a malicious manner while cooperating with each other. There is a problem with conventional memory forensics techniques in that, even when a plurality of programs including such malware are running while cooperating with each other, an analyst cannot recognize a relationship between the respective programs and therefore is unable to perform sufficient analysis.

### Means for Solving the Problem

In order to achieve an object of solving the problem described above, an analysis system according to the present invention includes: an extracting unit that extracts each running process and each thread in each process from data that records a state of a memory of an analysis object apparatus; an object acquiring unit that acquires an object belonging to the process or the thread having been extracted by the extracting unit; and a specifying unit that specifies a same object belonging to a plurality of processes or a plurality of threads among objects acquired by the object acquiring unit and that associates the plurality of processes or the plurality of threads to which the same object belongs.

### Effects of the Invention

According to the present invention, even when a plurality of programs are running while cooperating with each other, an effect of making a relationship between respective processes or threads recognizable and enabling sufficient analysis to be performed is achieved.

### BRIEF DESCRIPTION OF DRAWINGS

FIG. 1 is a diagram showing an example of a configuration of an analysis system according to a first embodiment.

FIG. 2 is a diagram for explaining association processing of processes and threads.

FIG. 3 is a diagram for explaining, with respect to a synchronization object, association processing of a waiting thread and an owner thread.

FIG. 4 is a diagram for explaining an application example of the analysis system.

FIG. 5 is a diagram for explaining an application example of the analysis system.

FIG. 6 is a diagram for explaining an application example of the analysis system.

FIG. 7 is a flow chart showing an example of a flow of processing in an analyzing apparatus according to the first embodiment.

FIG. 8 is a diagram showing a computer that executes an analysis program.

### DESCRIPTION OF EMBODIMENTS

Hereinafter, an embodiment of an analysis system, an analysis method, and an analysis program according to the present application will be explained in detail with reference to the drawings. It is to be understood that the analysis system, the analysis method, and the analysis program according to the present application are not limited by the embodiment described below.

### First Embodiment

In the following embodiment, a configuration of an analysis system 100 according to a first embodiment and a flow of processing by an analyzing apparatus 10 according to the first embodiment will be explained in this order, and an effect achieved by the first embodiment will be explained last.

[Configuration of Analysis System]

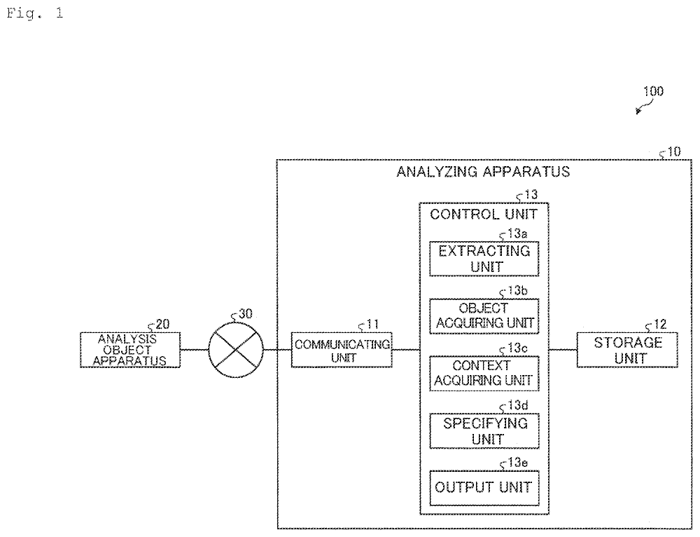

First, a configuration of the analysis system 100 will be explained with reference to FIG. 1. FIG. 1 is a diagram showing an example of a configuration of an analysis system according to the first embodiment. As illustrated in FIG. 1, the analysis system 100 includes the analyzing apparatus 10 and an analysis object apparatus (Personal Computer) 20. In addition, the analyzing apparatus 10 and the analysis object apparatus 20 are connected to each other via a network 30.

The analyzing apparatus 10 receives an input of a memory dump from the analysis object apparatus 20 and realizes a memory forensics technique of analyzing a relationship between processes or threads at the time of acquisition of the memory dump. In this case, a thread refers to a finer processing unit than a process. In addition, a process is generated when executing a program.

Furthermore, in the analyzing apparatus 10, objects respectively owned by processes or threads included in the memory dump are extracted and a plurality of processes or a plurality of threads owning a same object are associated with each other. Accordingly, for example, the analyzing apparatus 10 enables a synchronization wait state, a resource sharing state, and the like of application processes or threads running at the time of the memory dump to be analyzed from the memory dump.

In this case, it is assumed that an object refers to a resource such as a file, a registry, or a socket, a shared memory region or a memory region to which a same file is mapped, or an object for synchronization such as a mutex or a semaphore. In addition, the analyzing apparatus 10 extracts an execution context of a process or a thread and outputs an executed code region.

The analysis object apparatus 20 acquires a memory dump at a predetermined timing and transmits the acquired memory dump to the analyzing apparatus 10. For example, when a security incident occurs, the analysis object apparatus 20 acquires a memory dump recording a state of the memory and transmits the acquired memory dump to the analyzing apparatus 10.

The analyzing apparatus 10 includes a communicating unit 11, a storage unit 12, and a control unit 13. Hereinafter, processing of the respective units included in the analyzing apparatus 10 will be explained.

The communicating unit 11 is a communication interface that transmits and receives various types of information to and from another apparatus connected via a network or the like. The communicating unit 11 is realized by an NIC (Network Interface Card) or the like and performs communication with another apparatus via an electric communication line such as a LAN (Local Area Network) or the Internet. For example, the communicating unit 11 receives a memory dump from the analysis object apparatus 20.

In addition, the storage unit 12 stores data and programs required by various types of processing by the control unit 13. For example, the storage unit 12 is a semiconductor memory element such as a RAM (Random Access Memory) or a Flash Memory or a storage apparatus such as a hard disk or an optical disk. The storage unit 12 stores various types of data necessary for analysis processing.

The control unit 13 has an internal memory for storing a program that defines various processing procedures and required data and uses the program and the required data to execute various types of processing. For example, the control unit 13 is an electronic circuit such as a CPU (Central Processing Unit) or an MPU (Micro Processing Unit) or an integrated circuit such as an ASIC (Application Specific Integrated Circuit) or an FPGA (Field Programmable Gate Array). In addition, the control unit 13 includes an extracting unit 13a, an object acquiring unit 13b, a context acquiring unit 13c, a specifying unit 13d, and an output unit 13e.

The extracting unit 13a extracts each running process and each thread in each process from a memory dump that records a state of a memory of the analysis object apparatus 20. For example, the extracting unit 13a receives an input of a memory dump from the analysis object apparatus 20 and extracts a process object (an EPROCESS structure) that corresponds to each process running at the time of acquisition of the memory dump and a thread object (an ETHREAD structure) that corresponds to each thread in each process. In other words, the extracting unit 13a finds out structures owned by the OS and extracts processes and threads that have been running. It should be noted that a case of Windows (registered trademark) has been explained above as an example of an object. However, the present embodiment is not limited to Windows (registered trademark) and can be used in other OSs such as Linux (registered trademark) and Mac OS (registered trademark).

In addition, the extracting unit 13a may construct a virtual memory space if necessary when receiving an input of a memory dump from the analysis object apparatus 20. With a memory forensics technique, a physical memory alone is insufficient for comprehending an association with a process or, in other words, comprehending which address of the physical memory is being used by which process. Therefore, a correspondence between the physical memory and a virtual memory of an implemented process must be established. In this case, it is assumed that a virtual memory refers to a memory space as viewed from a process.

The object acquiring unit 13b acquires an object belonging to the process or the thread extracted by the extracting unit 13a. For example, the object acquiring unit 13b analyzes an object management table of process objects, lists various objects opened by a process corresponding to the process object by listing handles included in the object management table, and acquires the listed objects.

In other words, the object acquiring unit 13b finds which object a process or a thread had been using. In this case, a handle is something like a ticket for use for using a resource which enables a process or a thread to execute processing (for example, opening a file, securing memory, or performing an exchange (making a socket) for network communication) and is kept until the processing by the process or the thread is completed. By acquiring an object through a handle, a user can roughly comprehend what kind of resource a process or a thread had been using.

The context acquiring unit 13c acquires an execution context of the thread extracted by the extracting unit 13a. The purpose of extracting an execution context at this point is to analyze contents of the thread to comprehend which portion of a program had been executed and what kind of data had been handled. In addition, the context acquiring unit 13c acquires a stack trace obtained by a stack analysis.

The specifying unit 13d specifies a same object belonging to a plurality of processes or a plurality of threads among the objects acquired by the object acquiring unit 13b and associates the plurality of processes or the plurality of threads to which the same object belongs.

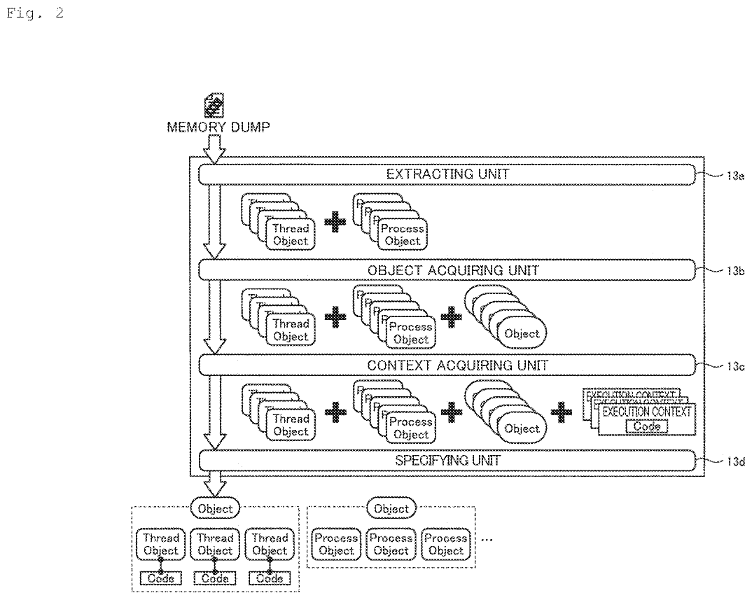

A series of analysis processing by the extracting unit 13a, the object acquiring unit 13b, the context acquiring unit 13c, and the specifying unit 13d of the analyzing apparatus 10 will now be explained with reference to FIG. 2. FIG. 2 is a diagram for explaining association processing of processes and threads. As illustrated in FIG. 2, first, when the extracting unit 13a receives an input of a memory dump, the extracting unit 13a extracts a process object that corresponds to each process running at the time of acquisition of the memory dump and a thread object that corresponds to each thread in each process.

Next, the object acquiring unit 13b acquires an object belonging to the process or the thread extracted by the extracting unit 13a. In addition, the context acquiring unit 13c acquires an execution context of the thread extracted by the extracting unit 13a.

Subsequently, the specifying unit 13d specifies a same object belonging to a plurality of processes or a plurality of threads among the objects acquired by the object acquiring unit 13b and associates the plurality of processes or the plurality of threads to which the same object belongs.

In addition, the specifying unit 13d may specify a synchronization object belonging to a plurality of processes or a plurality of threads among the objects acquired by the object acquiring unit 13b and associate a thread waiting for the synchronization object with a thread that owns the synchronization object.

For example, the specifying unit 13d refers to a synchronization wait list (a list of KWAIT_BLOCK structures) owned by each thread object and associates thread objects waiting for a same synchronization object.

Furthermore, when the synchronization object itself has owner information (for example, when the synchronization object is a Mutex object (a KMUTANT structure)), based on the information, the specifying unit 13d specifies the thread object owning the object.

In addition, when the synchronization object itself does not have owner information (for example, when the synchronization object is a Semaphore object (a KSEMAPHORE structure)), the specifying unit 13d specifies a process owning the synchronization object and makes a thread not listed as a waiting object among the threads belonging to the process an owner of the synchronization object. For example, with respect to processes A, B, and C which own a given synchronization object a, the specifying unit 13d checks whether threads A, B, and C in each process are in a wait state. Furthermore, when the threads B and C are in a wait state and the thread A is not in a wait state, the specifying unit 13d specifies the thread A as the owner of the synchronization object a.

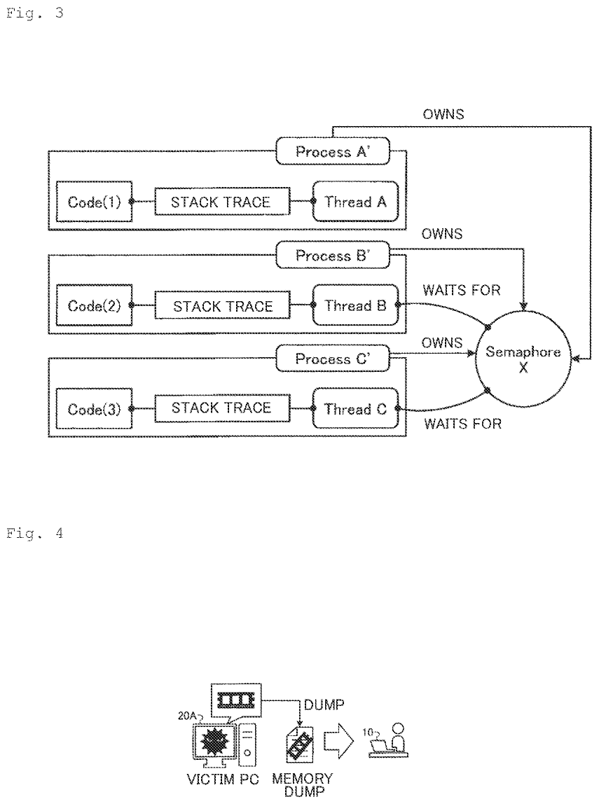

Processing of associating a waiting thread and an owner thread with each other with respect to a synchronization object will now be explained with reference to the example shown in FIG. 3. In the example shown in FIG. 3, a case where a Semaphore object of which a maximum number of owners is “1” is a synchronization object will be explained. As illustrated in FIG. 3, processes A′, B′, and C′ own a Semaphore object X (described as Semaphore X in FIG. 3), and threads B and C are waiting to own the Semaphore object X. In other words, since only the thread A belonging to the process A′ is not in a wait state, the specifying unit 13d can specify that the thread A is the owner. Therefore, the specifying unit 13d associates the threads B and C waiting for a synchronization object and the thread A that owns the synchronization object with each other.

While association of threads is performed based on a synchronization object (a KMUTANT structure or a KSEMAPHORE structure) and a synchronization wait list (a list of KWAIT_BLOCK structures), this method is not restrictive. For example, while threads or processes may be synchronized using an object that can be shared with a plurality of processes or threads such as a file, a registry, a named pipe, a socket, or a shared memory instead of a synchronization object, a synchronization object can be substituted by a data structure indicating the object and a management table, a list, or the like of objects owned by a thread or a process.

Returning to the description of FIG. 1, using an execution context, the output unit 13e outputs codes having been executed by the plurality of threads associated by the specifying unit 13d. For example, with respect to each synchronization object, the output unit 13e lists and outputs thread objects respectively corresponding to waiting threads and owner threads and code regions having been executed by the threads.

As described above, the analyzing apparatus 10 can list threads waiting for or owning a same synchronization object and code regions having been executed by the threads from a supplied memory dump.

The output unit 13e specifies a code having been executed by a thread from the execution context of the thread. Examples of the execution context include an execution context owned by a thread stored in a memory dump as a CONTEXT structure or a KTRAP_FRAME structure and a stack trace result obtained by analyzing a stack of threads. These are merely examples and the execution context is not limited thereto.

In addition, a memory dump to be input to the analyzing apparatus 10 is not limited to a specific memory dump format. Specifically, the analyzing apparatus 10 can not only use a physical memory dump and a virtual memory dump but also a live memory of a running computer, state save data created during a computer downtime, suspend data or a snapshot of a virtual machine, and the like. Furthermore, the analyzing apparatus 10 is not affected by a type or the like of an OS.

As described above, since the analyzing apparatus 10 enables a synchronization wait state, a resource sharing state, and the like of application processes or threads running at the time of the memory dump to be analyzed from the memory dump, the analyzing apparatus 10 is useful for memory analysis during an incident response. For example, as illustrated in FIG. 4, when a victim PC 20A infected by malware is an analysis object and a security incident occurs, the analyzing apparatus 10 receives a memory dump from the victim PC and performs memory analysis from the memory dump. This enables the analysis system 100 to use an analysis result to specify or remove a cause of the occurrence of the security incident and to restore system or business operations.

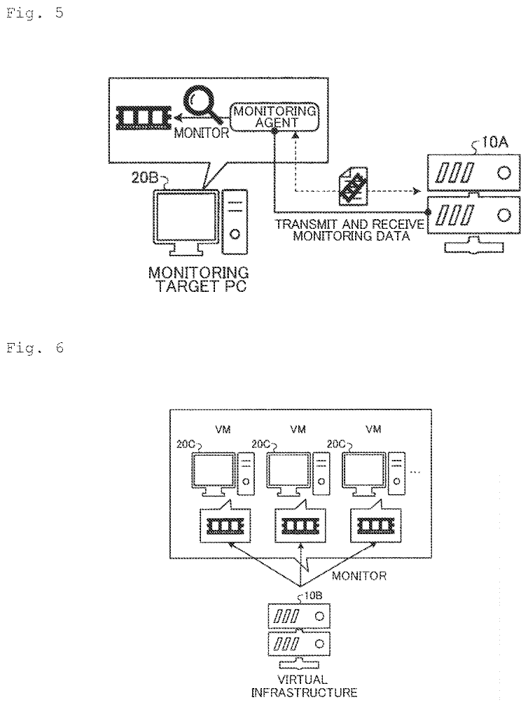

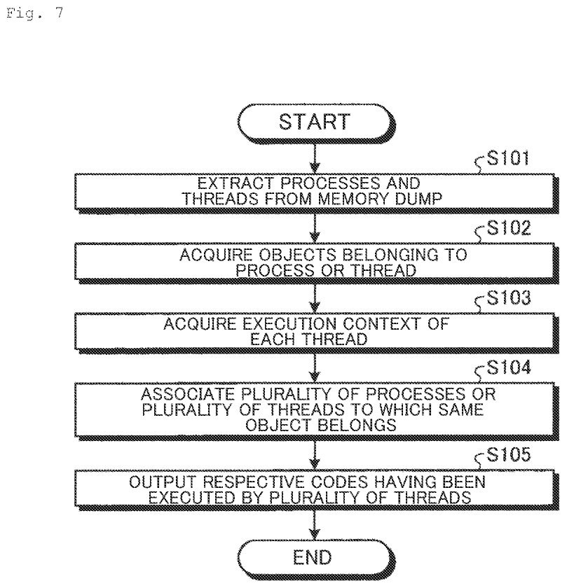

In addition, the analyzing apparatus 10 is also useful for threat monitoring and intrusion detection at an end point. For example, as illustrated in FIG. 5, with a monitoring target PC 20B as an analysis object, a threat monitoring server 10A to which functions of the analyzing apparatus 10 have been applied may receive monitoring data via a monitoring agent and analyze the monitoring data. Furthermore, as illustrated in FIG. 6, the analyzing apparatus 10 is also useful for monitoring a virtual machine from a virtual infrastructure. In the example shown in FIG. 6, with a plurality of VMs 20C that are monitoring targets as an analysis object, a virtual infrastructure 10B to which functions of the analyzing apparatus 10 have been applied may acquire data of each VM 20C and analyze the data.

[Processing Procedures of Analyzing Apparatus]

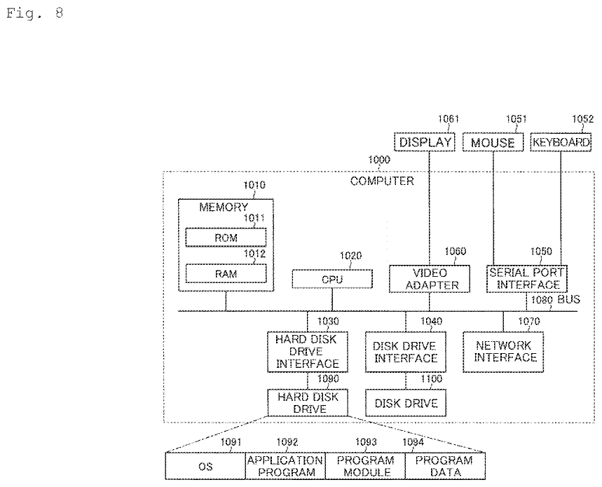

Next, an example of processing procedures of the analyzing apparatus 10 according to the first embodiment will be described with reference to FIG. 7. FIG. 7 is a flow chart showing an example of a flow of processing in an analyzing apparatus according to the first embodiment.

As illustrated in FIG. 7, the extracting unit 13a of the analyzing apparatus 10 extracts each running process and each thread in each process from a memory dump (step S101). For example, upon receiving an input of a memory dump from the analysis object apparatus 20, the extracting unit 13a extracts a process object that corresponds to each process running at the time of acquisition of the memory dump and a thread object that corresponds to each thread in each process.

In addition, the object acquiring unit 13b acquires an object belonging to the process or the thread extracted by the extracting unit 13a (step S102). For example, the object acquiring unit 13b analyzes an object management table of process objects and lists various objects opened by a process corresponding to the process object. Next, the context acquiring unit 13c acquires an execution context of each thread extracted by the extracting unit 13a (step S103).

Furthermore, the specifying unit 13d specifies a same object belonging to a plurality of processes or a plurality of threads among the objects acquired by the object acquiring unit 13b and associates the plurality of processes or the plurality of threads to which the same object belongs (step S104). For example, the specifying unit 13d specifies a synchronization object belonging to a plurality of processes or a plurality of threads among the objects acquired by the object acquiring unit 13b and associates a thread waiting for the synchronization object with a thread that owns the synchronization object.

Subsequently, using an execution context, the output unit 13e respectively outputs codes having been executed by the plurality of threads associated by the specifying unit 13d (step S105). For example, with respect to each synchronization object, the output unit 13e lists and outputs thread objects respectively corresponding to waiting threads and owner threads and code regions having been executed by the threads.

### Effect of First Embodiment

As described above, the analyzing apparatus 10 of the analysis system 100 according to the first embodiment extracts each running process and each thread in each process from a memory dump that records a state of a memory of the analysis object apparatus 20. In addition, the analyzing apparatus 10 acquires an object belonging to the extracted process or thread. Next, the analyzing apparatus 10 specifies a same object belonging to a plurality of processes or a plurality of threads among the acquired objects and associates the plurality of processes or the plurality of threads to which the same object belongs. Therefore, with the analysis system 100, even when a plurality of programs are running while cooperating with each other, a relationship between respective processes or threads can be made recognizable and sufficient analysis can be performed.

Generally, for the purpose of providing management and exclusive control functions of various resources to be accessed by each process or thread, an OS has a data structure for storing information on objects being opened by each process or thread. In particular, since a synchronization object and a thread related to the exclusive control function are also related to a scheduling function, it is necessary to manage which synchronization object is owned by or waited for by which thread. The analyzing apparatus 10 of the analysis system 100 utilizes these pieces of information held by the OS and detects processes or threads sharing a same object. In addition, a relationship can also be analyzed from a shared object. For example, in a case of a synchronization object such as Mutex or Semaphore, the analyzing apparatus 10 comprehends that a process or a thread owning the synchronization object operates while synchronizing the synchronization object. Furthermore, when a same memory is shared by a plurality of processes or threads, the analyzing apparatus 10 can make a determination that data is shared by the plurality of processes or threads.

In addition, an execution context of a process or a thread may be restorable from data remaining in a memory such as management data of an OS or a stack of processes or threads. Since data on a register used by a process or a thread is saved by the OS in a memory at a timing such as a context switch, the data can be acquired from a memory dump. Since the data includes an instruction pointer, the analyzing apparatus 10 can specify a code last executed by the process or the thread. Furthermore, since the analyzing apparatus 10 can acquire a stack trace by analyzing a stack, a part of an execution path can be obtained.

Accordingly, the analyzing apparatus 10 can also associate a code region that was being executed by the process or the thread. Therefore, the analyzing apparatus 10 makes a relationship between processes or threads owning a same object and, furthermore, a relationship between code regions having been executed by the processes or threads recognizable and enables sufficient analysis to be performed.

[System Configuration and the Like]

It is to be understood that each illustrated component of each apparatus is functional and conceptual and it is not required that each component of each apparatus be physically constructed as illustrated. In other words, specific modes of distribution and/or integration of each apparatus are not limited to the illustrated modes and all or a part thereof can be functionally or physically distributed and/or integrated in arbitrary units in accordance with various loads, usage, or the like. Furthermore, all of or a part of each processing function that is carried out by each apparatus may be realized by a CPU and a program that is analyzed and executed by the CPU or may be realized as hardware based on wired logic.

In addition, among processing steps described in the present embodiment, all of or a part of processing steps described as being automatically performed may be performed manually, or all of or a part of processing steps described as being manually performed may be performed automatically using known methods. Furthermore, information including processing procedures, control procedures, specific names, and various types of data and parameters set forth in the description given above and in the drawings can be arbitrarily changed unless otherwise specified.

[Program]

FIG. 7 is a diagram showing a computer that executes an analysis program. For example, a computer 1000 has a memory 1010 and a CPU 1020. In addition, the computer 1000 has a hard disk drive interface 1030, a disk drive interface 1040, a serial port interface 1050, a video adapter 1060, and a network interface 1070. These units are connected by a bus 1080.

The memory 1010 includes a ROM (Read Only Memory) 1011 and a RAM 1012. For example, the ROM 1011 stores a boot program such as a BIOS (Basic Input Output System). The hard disk drive interface 1030 is connected to a hard disk drive 1090. The disk drive interface 1040 is connected to a disk drive 1100. For example, an attachable/detachable storage medium such as a magnetic disk or an optical disk is inserted into the disk drive 1100. For example, the serial port interface 1050 is connected to a mouse 1051 and a keyboard 1052. For example, the video adapter 1060 is connected to a display 1061.

For example, the hard disk drive 1090 stores an OS 1091, an application program 1092, a program module 1093, and program data 1094. In other words, a program that defines various processing steps of the analyzing apparatus 10 is implemented as the program module 1093 on which codes executable by the computer are described. For example, the program module 1093 is stored in the hard disk drive 1090. For example, the program module 1093 for executing similar processing steps to the functional configuration of the apparatus is stored in the hard disk drive 1090. The hard disk drive 1090 may be replaced with an SSD (Solid State Drive).

In addition, data to be used in processing of the embodiment described above is stored as the program data 1094 in, for example, the memory 1010 or the hard disk drive 1090. Furthermore, the CPU 1020 loads the program module 1093 and the program data 1094 stored in the memory 1010 or the hard disk drive 1090 to the RAM 1012 and executes the program module 1093 and the program data 1094 when necessary.

The program module 1093 and the program data 1094 are not limited to being stored in the hard disk drive 1090 and, for example, the program module 1093 and the program data 1094 may be stored in an attachable/detachable storage medium and read by the CPU 1020 via the disk drive 1100 or the like. Alternatively, the program module 1093 and the program data 1094 may be stored in another computer that is connected via a network such as a WAN. In addition, the program module 1093 and the program data 1094 may be read from the other computer by the CPU 1020 via the network interface 1070.

### REFERENCE SIGNS LIST

10 Analyzing apparatus
11 Communicating unit
12 Storage unit
13 Control unit
13a Extracting unit
13b Object acquiring unit
13c Context acquiring unit
13d Specifying unit
13e Output unit
20 Analysis object apparatus
30 Network

1. An analysis system comprising:
processing circuitry configured to:
extract each running process and each thread in each process from data that records a state of a memory of an analysis object apparatus;
acquire an object belonging to the process or the thread having been extracted; and
specify a same object belonging to a plurality of processes or a plurality of threads among objects acquired associate the plurality of processes or the plurality of threads to which the same object belongs.

2. The analysis system according to claim 1, wherein the processing circuitry is further configured to specify a synchronization object belonging to a plurality of processes or a plurality of threads among the objects acquired and associate a thread waiting for the synchronization object with a thread that owns the synchronization object.

3. The analysis system according to claim 1, wherein the processing circuitry is further configured to:
acquire an execution context of the thread extracted, and
output, using the execution context acquired, a code having been executed by the plurality of threads associated.

4. An analysis method comprising:
extracting each running process and each thread in each process from data that records a state of a memory of an analysis object apparatus;
acquiring an object belonging to the process or the thread having been extracted; and
specifying a same object belonging to a plurality of processes or a plurality of threads among objects acquired and associating the plurality of processes or the plurality of threads to which the same object belongs, by processing circuitry.

5. A non-transitory computer-readable recording medium storing therein an analysis program that causes a computer to execute a process comprising:
extracting each running process and each thread in each process from data that records a state of a memory of an analysis object apparatus;
acquiring an object belonging to the process or the thread having been extracted; and
specifying a same object belonging to a plurality of processes or a plurality of threads among objects acquired and associating the plurality of processes or the plurality of threads to which the same object belongs.
